(19) United States
(12) Patent Application Publication
(10) Pub. No.: US 2002/0170878 A1
(43) Pub. Date: Nov. 21, 2002

(54) Etching resistance of protein-based photoresist layers

(75) Inventors: Z. Jeffrey Wang, Jamesville, NY (US); Leo B. Kriksunov, Ithaca, NY (US); Derek Harris, Woodbury, MN (US)

Correspondence Address: Mark A. Litman & Associates, P.A., 3209 West 76th St., York Business Center, Suite 205, Edina, MN, 55435, US

(73) Assignee: BMC Industries, Inc.

(21) Appl. No.: 09/819,295

(22) Filed: Mar. 27, 2001

(51) Int. Cl. C23F 1/00; B44C 1/22; C03C 15/00; C03C 25/68

(52) U.S. Cl. 216/41

(57) ABSTRACT

Etch resistance of protein-based resist compositions can be improved by treatment of the resist coatings with oxidizing salts prior to exposure of the resist coating to etchant solutions. For example, protein-based, film forming compositions comprising casein, fish glue or albumin can be hardened by the treatment of oxidizing salts (such as chlorates, chlorites, perchlorates, bromates, iodates, periodates, perbromates, and hypochlorite). These salts can be used to harden the protein-based film-forming compositions without environmental damage by appropriate selection of the cation (e.g., sodium, lithium, potassium, calcium, ammonium, organic cations, and the like). Etch resistance is improved such that ferric chloride or other acidic etchant solutions can be used in etching the metal surface or substrate containing the casein-based photoresist. In addition to this benefit, reduced burn-in temperatures may be used to harden the pattern, and the resist displays improved durability in rinse-dry cycles during the etching process.

### BACKGROUND OF THE INVENTION

1. Field of the Invention

The present invention relates to the field of etching, particularly resist layers used in etching, protein-based resist layers used in etching and improvements in those layers.

2. Background of the Art

Etch resist films are used in a wide variety of technical environments. The etch resists are deposited as a film on a substantive substrate, and sections of the resist are removed in a desired pattern. Surface areas of the substantive substrate are physically exposed through the openings formed in the resist layer, so that the surface of the substrate may be contacted by the application of etchant solutions. When the etchant solution is applied to the patterned resist layer, etchant solution contacts both the residual resist layer and the physically exposed surface of the substantive substrate. The etchant solution is chosen to etch the physically exposed substantive substrate and not etch (or etch at a relatively slow rate) the resist layer. Because the resist layer resists being etched by the solution, it protects the substantive substrate against being etched where the resist remains in contact with the surface of the substantive substrate. In this manner, a pattern is etched in the substantive substrate that matches the pattern that had been removed from the resist layer.

The physical properties of a resist material have many various and distinct requirements. The resist material must be easily coated onto a substrate, it must bond well to various substrates, it must harden to form a coating with structural integrity, it must resist specific etchants, and usually must be easily removable after the etch/resist process has been performed. Once a material or class of materials has been found to provide many of these properties based on its native ability, the range of properties must be improved and optimized by adjuvants or other modifications made to the fundamental composition. A typical way of improving the strength of a resist film, for example, is to form three-dimensional bond (cross-link) the composition.

Photosensitive etch resistant films based on aqueous solutions of natural products such as fish glue, albumin, and casein have been known for a number of years. One such useful photoresist composition comprises water, casein, made by acid precipitation of milk, an alkali metal base to impart a pH of 7.7 or higher (which improves the solubility of the natural product in the water), and an ammonium dichromate sensitizer. U.S. Pat. No. 4,061,529(Goldman and Datta) discloses the addition of sodium borate as the base in a concentration such that the photoresist solution has the final pH of 6.7 to 7.3, to improve the pot life of the coating composition and the shelf life of coated substrates.

These resists have been employed extensively in the lithographic printing arts and in the manufacture of shadow masks for television monitors. A cleaned metal, e.g., copper, surface or substrate is coated with the aqueous photoresist solution and dried. A mask having the desired pattern is contacted to the resist and exposed to light of an appropriate wavelength which hardens the resist in the exposed areas. The resist film is then washed with water to dissolve the unexposed resist and thereby uncover part of the metal surface. The now partially coated substrate is then dried and baked for about 5 minutes at a temperature of from about 260-287° C. This step is required to render the remaining photoresist etch resistant. The partially coated substrate is then etched by spraying with hot ferric chloride solution, which etches away the bared metal portions. The residual resist can then be removed by hot alkali solution.

The above process has certain limitations that restrict its use in other high production manufacture which employ lithographic techniques; in particular, in the manufacture of printed circuit boards wherein a copper-clad substrate, such as a phenolic impregnated paperboard, is etched to form a pattern of conductors to which various components are soldered. Generally, these printed circuit boards are made by screen printing an etch resistant ink onto the boards and etching the exposed metal areas. However, this method is not able to define line widths and spacings sufficiently small as is now demanded by the increasing miniaturization of components on printed circuit boards. Photolithographic techniques to define such fine pattern spacings must then be employed if high yields are to be obtained.

U.S. Pat. No. 4,230,794 describes that the etch resistance of a casein-based photoresist pattern to low specific gravity ferric chloride based etchant solutions is increased by treating the photoresist pattern with a formaldehyde solution containing at least 10 percent formaldehyde by volume by a period of at least 30 seconds, and thereafter drying the photoresist pattern.

U.S. Pat. No. 4,259,421 describes that the etch resistance of a casein-based photoresist pattern to low specific gravity ferric chloride-based etchant solutions is increased by treating the photoresist pattern with a methylene blue solution, containing at least 0.1 weight percent methylene blue, prior to exposure to the etchant solution.

U.S. Pat. No. 4,865,953 describes a method comprises applying to a surface to be etched a coating of a borax-free, low dichromate, casein photoresist liquid composition comprising an acid-precipitated casein, sodium hydroxide as an alkalizing agent, an alkali dichromate photosensitizer and water. The composition has a pH in the range of 6.0 to 7.0, and reduced quantities of the alkalizing agent and photosensitizer compared to prior coating compositions.

The pattern is made in the resist layer by applying a resist film over the copper layer, exposing and developing the resist to create a pattern of resist and exposed copper. The copper is etched away in the exposed areas, and the residual resist is removed, leaving a patterned copper layer on the board. At present, organic-based photoresists are used because the high temperatures required to cure water-based resists may have adverse effects on phenolic impregnated paper substrate.

One attempted method to deal with this high temperature-curing problem of the water-based photoresist is disclosed by U.S. Pat. No. 4,158,566, wherein an accelerator is used with such water-based photoresist compositions. As an accelerator there is disclosed N-methylol acrylamide which, when added to a casein-based photoresist composition, lowers the curing temperature required to make the photoresist etch resistant to a temperature of about 125-135° C., and enables such compositions to be employed in printed circuit board manufacture.

Another method dealing with the etch resistance of water-based photoresists is disclosed in U.S. Pat. No. 4,237,210, wherein it is disclosed that such photoresists are etch resistant or sufficiently etch resistant to allow the use of the same in the manufacture of printed circuit boards if certain process parameters are maintained. These parameters include the use of a minimum thickness (4.0 micrometers or above) of photoresist film, the use of a specific type (low hardness content) of water in developing the patterned photoresist, and the use of an etchant solution having a certain minimum specific gravity (1.34 or above).

There is a continuing need for improved etch resistance in water-based photoresists. Resists with improved etch resistance will significantly reduce the defects from resist failure. This then, increases the yield in the manufacturing process, whether the process is for a printed circuit board, cathode ray tube shadow mask, or printing surface. Additionally, there is great importance that is attached to the environmental effects of resist compositions and the effluents from the etching solutions. For example, the chromate ions (e.g., chromic acid) used for treatment of the casein-based resist layer comprise heavy metals that have reported toxic effects, and reduction in their usage is desirable. Formaldehyde used as a hardening agent for many organic compositions and protein-based compositions (e.g., gelatin) are highly noxious and also have toxic effects. There is a clear need for additives to protein-based compositions to improve their properties without adding detrimental materials to the environment.

### SUMMARY OF THE INVENTION

Etch resistance of the protein-based resists (casein, fish glue or albumin) can be improved by a treatment with oxidizing salts prior to the exposure of the surface to the etchant solutions. For example, protein-based film-forming compositions comprising casein, fish glue, or albumin can be hardened by treatment with oxidizing salts (such as, for example, chlorates, chlorites, perchlorates, bromates, iodates, periodates, perbromates and hypochlorites). These salts can be used to harden the protein-based film-forming compositions without environmental damage by appropriate selection of the cation (e.g., sodium, lithium, potassium, calcium, ammonium, organic cations, and the like). Etch resistance is improved such that ferric chloride, copper chloride and other acidic etchant solutions can be used in etching the metal surface or substrate containing the casein-based photoresist. In addition to this benefit, reduced burn-in temperatures may be used to harden the pattern, and the resist displays improved durability in rinse-dry cycles in the process.

After the coating has been dried onto the substantive substrate surface, and most particularly, after the resist pattern has been exposed and developed, it is common in the resist industry to burn-in the pattern. Elevated temperatures (e.g., above 100° C., above 105° C., above 200° C., above 250° C., etc.) are used to further harden the resist pattern, the process especially sharpening and hardening features in the resist pattern. The resist treated with the method of the present invention tends to be measurably sturdier and can resist damage that could occur in the subsequent etching process. The resist treated with the method of the present invention also is more durable with respect to damage that could occur during the rinse-fry cycles in the etching process.

### DETAILED DESCRIPTION OF THE INVENTION

The invention includes the method of producing a protein-based (e.g., casein-based) photoresist pattern of improved etch resistance and reduced environmental impact. The method comprises forming treating a dried casein-based photoresist pattern (e.g., whether formed by printing, photoresist development, thermal development, etc.) with an oxidizing anion solution which further hardens the casein, particularly an oxidizing anion solution with an environmentally acceptable cation, prior to exposure to the etchant solution. The oxidizing anion solution should contain at least 0.05 weight percent oxidizing salt by weight. Other additives may be present in these solutions which further harden the casein or act in a similar manner as the oxidizing salt solutions (e.g., methylene blue solution) are contemplated by, may be used in and are included in this invention.

A preferred method may be carried out by applying a casein-based photoresist solution to a substrate surface (such photoresist solutions are well documented in the art), drying the photoresist solution on the substrate to form a photoresist film, exposing the dried photoresist film to actinic radiation, such as through a photomask, developing the exposed photoresist film to leave a photoresist pattern on the substrate surface, treating the photoresist pattern with the oxidizing salt solutions of the invention which further hardens the casein, and thereafter air drying the substrate to produce a photoresist pattern of improved etch resistance. The process may also include the further steps of etching the patterned substrate, e.g., with a ferric chloride-based etchant solution (e.g., a ferric chloride solution having a specific gravity between 1.2 and 1.6) to etch those portions of the substrate surface not protected by the photoresist pattern, and stripping the remaining photoresist from the substrate in a hot alkali solution to leave a patterned surface layer on the substrate. The substrate to be etched may include, by way of a non-limiting list of examples, metals, metal coated substrates, composites, and the like such as copper, iron, nickel, cobalt, aluminum, alloys and polymeric or crystalline surfaces coated with those metals.

The aqueous protein solutions, such as the casein solutions, used in the process of this invention comprise protein (e.g., casein) as the sensitizable protein material, sodium hydroxide (potassium hydroxide or other strong metal or alkaline earth hydroxides) as the alkalizing agent for the casein, photosensitizer for the casein (e.g. 0.05 to 4% by weight of the photoresist composition, e.g., alkali dichromate), and water. Optionally, small amounts of a surfactant, and adhesion promoter, a sensitivity enhancer, and/or a dye may also be added, if desired. In addition to these ingredients, these solutions may also contain the accelerator N-methylol acrylamide, which may be employed in amounts of from about 3 up to about 30 percent by weight of the casein present in the solution. The casein employed may be any acid precipitated casein and usually comprises from about 6 to about 12 percent by weight of the photoresist composition.

The alkalizing agent is added to solubilize the casein and is added in sufficient amount such that the pH of the final photoresist solution is from about 6.3 to 7.9, e.g., 6.7 to about 7.3. Sodium hydroxide is the preferred alkalizing agent. Generally, amounts of from about 5 to 30% or 8 to about 20 percent by weight of the casein (based on the total weight of the solution) are sufficient, but additional amounts may be required to bring the pH to the desired level.

The photosensitive agent used for curing casein can be dichromate (such as alkali metal dichromate, ammonium dichromate), water-soluble azide compounds (e.g., 4,4′-diazidostilbene-2,2′-disulfonate), onium salts (e.g., triarylsulfonium salts, diaryliodonium salts, e.g., methyltretramethylenesulfonium trifluoromethanesulfonate), a mixture of a sensitizer, an oxidizing agent and a metallocene complex salt (e.g., isopropylthioxanthone, triphemylmethylhydroperoxide, and toluene-cyclopentadienyl-Iron II trifluoromethanesulfonate), and the like. The photosensitive agent may also be a mixture of two or more of the above photosensitive agents, or newly developed or other existing photosensitive agents. Ammonium dichromate is the preferred photosensitive agent. However, other dichromates, such as sodium, lithium and potassium dichromate, may also be employed. The sensitizer is usually added in amounts of from about 2 to about 20 weight percent of the casein present. The amount of water added to the solution is adjusted to regulate the viscosity and the thickness of the resultant photoresist coating. Other inert binding agents may be present in the solution, along with materials to adjust the pH.

These aqueous solutions can be prepared by heating deionized water to about 50-60° C. and dissolving the sodium hydroxide and surfactant. The casein may be then added in a small but steady stream with vigorous agitation until dissolved; usually about 30 to 40 minutes is sufficient. After the resultant solution is heated to an elevated temperature (e.g., above 50° C., preferably above 60° C., and more preferably above 70° C., e,g, 75° C.), it is then cooled to room temperature and filtered. Just prior to use, the dichromate sensitizer is added and the pH is adjusted, if required, with sodium hydroxide. If used, N-methylol acrylamide may be then added.

The aqueous solutions used in the present method can be applied to the substrate by dipping, spin coating, roller coating, gravure coating, meniscus coating, curtain coating, spray coating and the like. The thickness of the coated photoresist film (which may also be partially controlled by adding liquid thickeners such as silica, thixotropic agents viscosity modifiers, acrylic resins, etc.) is usually maintained in the range of from about 10 to 200 micrometers, e.g., about 20 to 160 micrometers, and preferably about 50-160 micrometers. Application of the aqueous solution may be repeated to obtain the desired thickness of the coating.

After the photoresist coating has been applied to the substrate, it is dried, usually employing air drying or a source of infrared light or both. The photoresist is then exposed to an ultraviolet light source, such as a carbon arc, xenon, or a mercury lamp through a photomask, which exposure hardens the coating in the exposed areas. The photoresist may also be spectrally sensitized to enable visible radiation exposure. The exposed photoresist is then developed by flushing with water, which removes the unexposed portions of the resist, leaving the desired pattern of photoresist film on the substrate. After being developed the substrate with the photoresist pattern is, according to the invention, treated with the oxidizing salt solution to improve the etch resistance of the photoresist pattern. The oxidizing salt solution is preferably one which contains from about 0.05 to about 5.0 percent oxidizing salt by total weight of the solution. The treatment or exposure of the photoresist pattern to the oxidizing salt solution is one which is carried out for a period of approximately 1 minute and preferably in the range of from about 30 seconds to three minutes, although with higher power exposure systems, shorter times may be used, and with potentially radiation sensitive substrates, lower power and therefore longer exposures may be used. Thereafter, the substrate and photoresist pattern is dried, e.g., air dried.

The oxidizing salt treatment compositions used in the practice of the present invention comprise aqueous solutions of the oxidizing salts. Such oxidizing salts, for example, could include metal oxidizing salts, particularly oxidizing alkali metal or alkaline metal salts, especially such salts of oxidizing halogen salts, improve the durability of protein-based resist compositions during resist processes. Oxidizing halogen salt anions, for example, may have structural formulae of, for example:

XOₘⁿ⁻

Wherein X is Br, Cl, I or F,

m is 1, 2, 3or 4, and

n is 1 or 2,

with the anions comprising, for example, chlorate, chlorite, hypochlorite, perchlorate, bromate, perbromate, iodate, periodate, and the like.

The process of the invention may be further carried out by etching the exposed portions of the metal surface or substrate with an etchant solution (e.g., a ferric chloride-based etchant solution) to etch away those portions of the substrate or substrate surface not protected by the patterned etch resistant coating. The etchant can be, for example, ferric chloride, cupric chloride, and other acidic solutions, especially solutions of metal slats with strongly acidic anions. The preferred etchant solution for use in the practice of the present invention is a ferric chloride bases etchant with a specific gravity between 1.20 and 1.60 g/cm². Following etching, the remaining photoresist on the substrate may be removed by a warm, dilute basic solution, e.g., aqueous 2 to 10 percent by weight sodium hydroxide at 50-80° C., to leave a patterned metal surface on the substrate.

To illustrate the invention and the improved process thereof with greater particularity, the following specific, but non-limiting examples are included. These examples are intended to illustrate the invention only and are not intended to limit practice of the invention in any way. All compositions are based on weight percentages, unless otherwise stated.

### EXAMPLES

### Example 1

A panel of aluminum-killed steel (100 micrometers thick) was cleaned, coated with an aqueous-based photoresist and dried in an Infrared (IR) drying oven. The resist comprised an aqueous solution of about 10% (by weight) casein, 1% (by weight) ammonium dichromate, 1.5% additives, including a surfactant, an adhesion promoter and a photosensitivity enhancer. The resist was coated to a dry thickness of 9 micrometers. The coated panel was then exposed through a photomask for approximately 80 seconds with a mercury vapor lamp. The coating was then developed with a hot water spray and air dried.

The panel with the developed resist image pattern was then immersed in a 5% (by weight) solution of sodium chlorate for two minutes to harden the developed resist coating. After the treatment, the panel was etched with a ferric chloride-based etchant solution containing 4.3 M ferric chloride and 0.035 M hydrochloride acid and having a specific gravity of approximately 1.49 at a temperature of 66° C. and a pressure of 40 pounds per square inch for 9 minutes. After etching, the resist of the invention did not show any signs of breakdown or failure. The remaining resist layer was then stripped from the panel with a hot sodium hydroxide solution. An etched pattern remained on the panel.

In a comparative example, Example 1 was repeated without the sodium chlorate solution. After etching, breakthrough in the resist layer was observed.

### Examples 2-6

Panels were prepared using the same process conditions as in Example 1, but the sodium chlorate solution was treated with other examples of oxidizing salt solutions as shown in the Table below. The treated panels were then etched under the conditions of Example 1, with the various treatment times with the oxidizing salt solutions shown.

| | TREATMENT | | |
|---|---|---|---|
| | CONDITION | TIME | |
| EXAMPLE | (w/w %) | (minutes) | RESULTS |
| 1 | 5% Na | 2 | No |
| | Chlorate | | Breakthrough |
| 2 | 5% Na | 2 | No |
| | Perchlorate | | Breakthrough |
| 3 | 5% Na | 2 | No |
| | Bromate | | Breakthrough |
| 4 | 5% Na | 2 | Minor |
| | Iodate | | Breakthrough |
| 5 | 5% Na | 2 | Minor |
| | Periodate | | Breakthrough |
| 6 | Na | 0.33 | No |
| | Hypochlorite | | Breakthrough |
| | (10-13% | | |
| | available Cl) | | |
| Control | None | Not | Significant |
| | | Applicable | Breakthrough |

The results show that the oxidizing salts, particularly oxidizing alkali metal or alkaline metal salts, especially such salts of oxidizing halogen salts, improve the durability of protein-based resist compositions in the etching process.

What is claimed:

1. A method of etching a substrate comprising providing a protein-based resist patterned layer on a substrate, applying a solution of an oxidizing salt to the resist patterned layer, and contacting the resist pattern with an etchant solution to etch the substrate where the substrate is exposed through the resist pattern.

2. The method as set forth in claim 1 wherein said etchant solution comprises an acidic etchant.

3. The method of claim 2 wherein the acidic etchant is selected from the group consisting of ferric. chloride and cupric chloride.

4. The method of claim 1 wherein the substrate is selected from the group consisting of metal substrates, metal alloys, and metal-coated substrates.

5. The method of claim 4 wherein a metal layer in the substrate is selected from the group consisting of copper, iron, nickel, cobalt and alloys of at least one metal selected from the group consisting of copper, iron, nickel, and cobalt.

6. The method of claim 1 wherein the protein-based resist comprises a casein-based layer of patterned resist.

7. The method of claim 2 wherein the protein-based resist comprises a casein-based layer of patterned resist.

8. The method of claim 1 wherein the oxidizing salt comprises an ammonium, sodium, lithium, potassium, or calcium salt of an oxidizing anion.

9. The method of claim 2 wherein the oxidizing salt comprises an ammonium, sodium, lithium, potassium, or calcium salt of an oxidizing anion.

10. The method of claim 3 wherein the oxidizing salt comprises an ammonium, sodium, lithium, potassium, or calcium salt of an oxidizing anion.

11. The method of claim 4 wherein the oxidizing salt comprises an ammonium, sodium, lithium, potassium, or calcium salt of an oxidizing anion.

12. The method of claim 8 wherein the anion has the general formula:
XOₘ ⁿ⁻
wherein X is Br, Cl, I or F,
m is 1, 2, 3or 4, and
n is 1or 2.

13. The method of claim 9 wherein the anion has the general formula:
XOₘ ⁿ⁻
wherein X is Br, Cl, I or F,
m is 1, 2, 3 or 4, and
n is 1 or 2.

14. The method of claim 10 wherein the anion has the general formula:
XOₘ ⁿ⁻
wherein X is Br, Cl, I or F,
m is 1, 2, 3 or 4, and
n is 1 or 2.

15. The method of claim 11 wherein the anion has the general formula:
XOₘ ⁿ⁻
wherein X is Br, Cl, I or F,
m is 1, 2, 3 or 4, and
n is 1 or 2.

16. The method of claim 8 wherein the anion is selected from the group consisting of chlorate, chlorite, hypochlorite, perchlorate, bromate, perbromate, iodate, and periodate.

17. The method of claim 9wherein the anion is selected from the group consisting of chlorate, chlorite, hypochlorite, perchlorate, bromate, perbromate, iodate, and periodate.

18. The method of claim 10 wherein the anion is selected from the group consisting of chlorate, chlorite, hypochlorite, perchlorate, bromate, perbromate, iodate, and periodate.

19. The method of claim 11 wherein the anion is selected from the group consisting of chlorate, chlorite, hypochlorite, perchlorate, bromate, perbromate, iodate, and periodate.

20. The method of claim 16 including the further step of stripping the remaining photoresist pattern by treating with a hot alkali solution.

21. The method of claim 17 wherein said oxidizing salt solution contains from about 0.1 to about 5.0 percent by weight of oxidizing salt.

22. The method of claim 18 wherein the protein-based resist comprises a casein-based resist having dichromate therein.

23. A method of producing a resist pattern on a substrate comprising:
(a) applying a protein-based resist solution to a substrate;
(b) drying the resist solution on said substrate to form a resist film;
(c) forming a pattern of the resist film on the substrate; the improvement comprising
(d) treating the resist pattern with a solution comprising from 0.1 to 5% by weight of an oxidizing salt.

24. The method of claim 23 wherein the resist solution comprises casein.

25. The method of claim 23 wherein the oxidizing salt has the general formula of:
XOₘ ⁿ⁻
wherein X is Br, Cl, I or F,
m is 1, 2, 3 or 4, and
n is 1 or 2.

26. The method of claim 23 wherein the anion of the oxidizing metal salt is selected from the group consisting of chlorate, chlorite, hypochlorite, perchlorate, bromate, perbromate, iodate, and periodate.

27. The method of claim 26 wherein the resist pattern is burned-in after step (d).
